(19) United States
(12) Patent Application Publication
(10) Pub. No.: US 2023/0093562 A1
(43) Pub. Date: Mar. 23, 2023

(54) METHOD FOR TREATING SLUDGE USING SOLAR THERMAL CONCENTRATORS

(71) Applicant: University of Louisiana at Lafayette, Lafayette, AL (US)

(72) Inventors: Mark E. ZAPPI, Lafayette, LA (US); Terence Chambers, Lafayette, LA (US); Wayne Sharp, Lafayette, LA (US); Rafaei Hernandez, Lafayette, LA (US); Daniel Gang, Lafayette, LA (US); William Holmes, Lafayette, LA (US)

(73) Assignee: University of Louisiana at Lafayette, Lafayette, LA (US)

(21) Appl. No.: 17/946,919

(22) Filed: Sep. 16, 2022

Related U.S. Application Data
(60) Provisional application No. 63/245,366, filed on Sep. 17, 2021.

(51) Int. Cl. C02F 11/00; C02F 11/15

(52) U.S. Cl. CPC C02F 11/004; C02F 11/006; C02F 11/15; C02F 2303/04; C02F 2303/06; C02F 2305/10; C02F 2209/003; C02F 2201/002; C02F 2201/009; C02F 2201/3228

(57) ABSTRACT

This invention is a novel method to thermally process wet WWTP sludges, including biosolids, so that they can be classified. Wet biosolids or other WWTP sludges are passed through the heating zones of one or more solar thermal systems so that the sludges are heated to a target temperature to meet the requirements for U.S. Environmental Protection Agency classification. Various catalysts are provided before the sludges enter the heating zone and within the heating zone to optimize the treatment of the sludges.

### CROSS REFERENCE TO RELATED APPLICATIONS

This application claims benefit of priority under 35 U.S.C. § 119(e) of U.S. Ser. No. 63/245,366, filed Sep. 17, 2021, the entire contents of which is incorporated herein by reference in its entirety.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the Method for Treating Sludge Using Solar Thermal Concentrators, which may be embodied in various forms. It is to be understood that in some instances, various aspects of the invention may be shown exaggerated or enlarged to facilitate an understanding of the invention. Therefore, the drawings may not be to scale.

FIG. 1 is a Schematic of a Solar Thermal Concentrating Trough System (Power Generation).

FIG. 2 is Solar Thermal Concentrating Trough with Treatment Pipe.

FIG. 3 is Solar Concentrating Trough with Treatment Trough.

FIG. 4 is Solar Thermal Concentrating Tower.

FIG. 5 is an example Implementation of Schemes of the Invention.

FIG. 6 is an example of Solar Concentrating through a Dish Configuration.

### BACKGROUND

The US produces over 8,000,000 dry tons of biosolids per year. Biosolids are the final sludges that are generated at wastewater treatment plants (WWTPs) after all sludge processing is complete that requires off-site disposal and/or management.

Exiting WWTP are typically dewatered biosolids, treated water effluents, and biogas. The source of the biosolids are digested sludges produced from within WWTPs (primary, skimmer, and wasted secondary sludges or aka. raw sludges). About 80% of biosolids in the US are either land applied (aka land farming) or placed into landfills, at about an even 50/50 tonnage split. The balance is either incinerated or processed via some other method (drying, pyrolysis, etc.). The average cost in the US to either land apply or landfill biosolids is about $70/dton.

Biosolids being land applied are either classified as Class A or Class B sludges by the USEPA. Class A sludges have been processed to deactivate potential pathogens so that the sludge can be openly used by farmers and the general public without concerns over pathogens being present and/or the WWTP being liable for diseases stemming from the handling of the sludge. Often times, Class A sludge is used by homeowners and agricultural industry (along with some investors) as ag-amendments to gardens and fields. However, processing biosolids into Class A sludge requires heat and contact time, often at a great cost (may add >$30/dton of processing costs and in some cases as much as $300/dton). Class B sludge cannot be released to the public and must go into permitted land farming or landfilling operations at the ˜$70/dton tipping fee. More recently, finding a location for sludge disposal has been a challenge for the wastewater treatment industry because landfills are becoming more difficult to receive regulatory authorization and to construct. Further, open land farm acreage is also hard to site.

In the US, adding lime or caustic is the most often used method to heat the sludge and achieve a “classified” status, which is desired. However, this method is costly and difficult to implement. Further, it is not typically applied at the actual WWTP due to space requirements and chemical handling.

Biosolids are produced after the raw WWTP sludges are placed into a digester for microbes to degrade the mass of sludge into a lesser tonnage—often times, about 50% degradation of the input sludge mass is microbially degraded. Digestion is performed to both remove the pathogen threat and reduce the tonnage of sludge requiring disposal. Anaerobic digestion (AD) is the most commonly used method to digest sludge. AD uses anaerobic microbes to perform its digestion with both wet biosolids and biogas (a gas composed mainly of methane and carbon dioxide) being the main products. Aerobic digestion (aka extended aeration) is also used, but only wet biosolids are produced with aerobic microbes performing the digestion.

Exiting digestion, biosolids are about 0.3% to 3% solids. Sometimes, the post-digestion sludge is gravity thickened prior to dewatering (belt press, drying beds, or centrifuge). Dewatering will bring the final sludge or biosolids exiting the WWTP to about 15 to 25% solids within typical operations. Processing for pathogen/further stabilization to achieve “classification” as per USEPA standards/regulations is often performed off-site at an additional cost as part of the final biosolids management.

Solar thermal systems are a power-producing category of solar energy equipment that concentrates sunlight into a field of concentrated light so that at the focal zone, temperatures exceeding 500 degrees Fahrenheit are obtained (often much higher depending on the concentrating method, sunlight irradiation flux, and system efficiency). This inventive system and method uses this technique to address the issue of sludge treatment from WWTP.

Water or some heat carrying medium is pumped through the concentrated light zones to absorb the heat resulting in a heated medium that is directly or indirectly used to produce steam that drives a power generation system to produce electricity. The two most common designs are a parabolic mirror trough or a centralized tower with concentric receiver arrays. In either case, the medium passed through the heating zones can be heated to very high temperatures (function of concentration ratio, contact time in the heating zone, irradiation, and mass flow rate of the fluid being placed into the hearing zone). Temperatures in excess of 500° F. are common.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

This invention is a novel method to thermally process wet WWTP sludges, including biosolids, so that they can be classified (mainly, as Class A or B). Wet biosolids or other WWTP sludges are passed through the heating zones of solar thermal systems so that the sludges are heated to a target temperature to meet the requirements for U.S. Environmental Protection Agency classification. Class A is the target, although in some applications, Class B may also be acceptable. In one or more embodiments, the inventive method can also be applied to any microbial suspensions that contain pathogens or microbial populations that may be harmful to humans or animals.

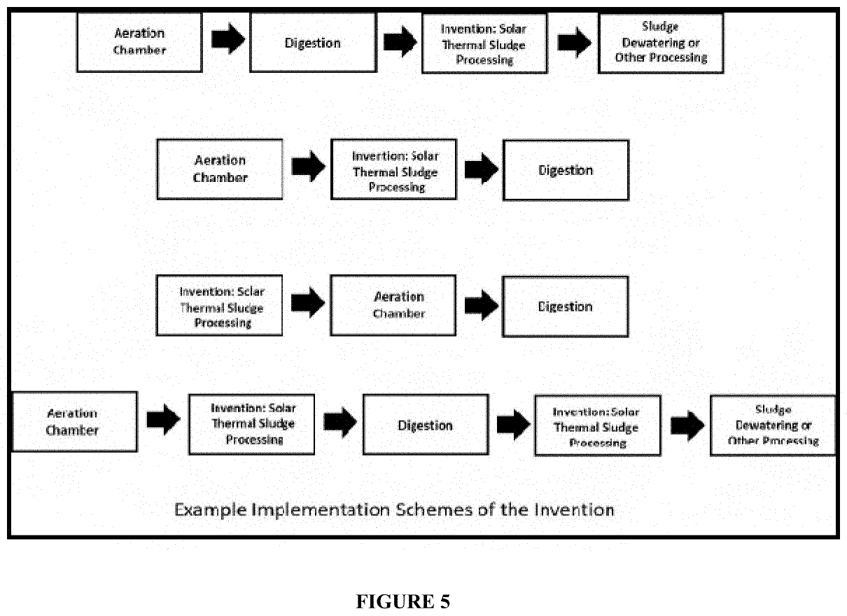

Flowrate can be controlled to hit a targeted Concentration-Exposure time of treatment (often referred to as C-T dosing, where concentration is taken as temperature). Said process is effective for all pathogens including bacteria (such as E-Coli) and viruses (such as SAR-COV-2). FIGS. 1-6 show various embodiments. FIG. 5 is a block diagram for the heating system.

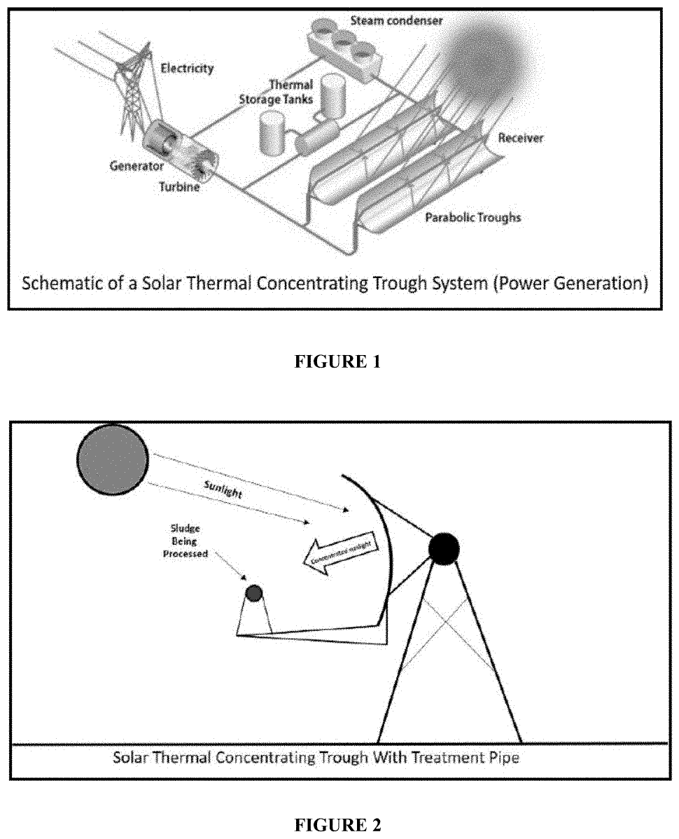

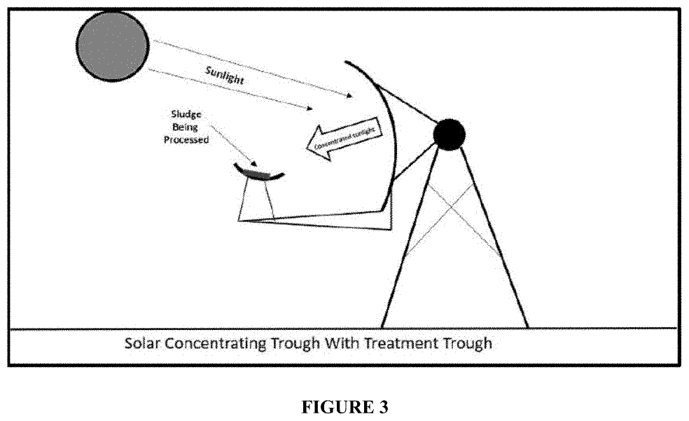

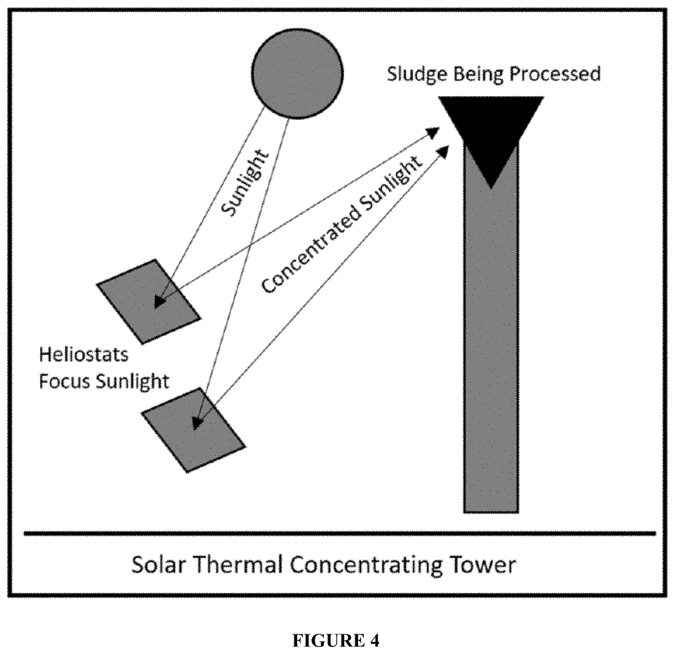

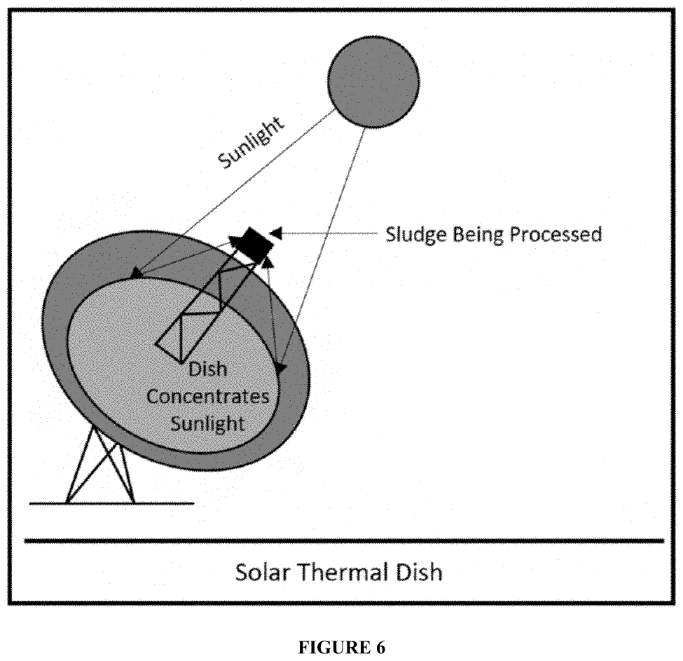

The invention requires a heating zone (sometimes referred to herein as a solar thermal trough or tower or dish or other configuration) with at least one heating contact chamber. A number of physical configurations are contemplated and presented in the figures. As depicted, FIG. 1 shows a solar thermal concentrating trough system used for power generation. FIG. 2 shows a solar thermal concentrating trough with a treatment pipe. FIG. 3 shows a solar concentrating trough with a specific treatment trough. FIG. 4 shows a solar thermal concentrating tower rather than a trough. And FIG. 6 shows a solar concentrating through with a dish configuration.

Concentrating Solar Thermal technology is used to produce a heating zone where WWTP sludges are passed through this zone to kill pathogens due to the generated heat and UV rays along with potential photon and heat sensitizers that may be added into the sludge slurries. Chemical oxidizers may be added to provide additional photo-stimulated pathogen destruction. Photo catalysts, such as titanium dioxide, may be added within the heating zones to form oxidizers to assist in pathogen destruction and sludge conditioning. Also, heat absorbents, such as salts and carbon, may be added to increase the heat capacity and heat absorption rate of the sludges.

Chemical oxidizers, including but not limited to ozone, hydrogen peroxide, sulfur dioxide, permanganates, and a combination of chemical oxidizers, are added to the sludge prior to passage through the heat zones. This step supplies parent oxidizers and also produces radical species while increasing reaction temperatures which facilities a more rapid and complete disinfection.

Photosensitizers, such as ketones and dyes may be used to enhance the extent and rate of reactions and disinfection, are added into the sludge prior to entrance of the sludge into the heat zone.

Photocatalysts, such titanium dioxides or zinc oxides, may be added into the sludge prior to entrance into the heat zone as a means of producing radical species.

Further, the pH of the influent sludge may be adjusted to enhance targeted reactions.

Photometers may be added into the heating zone contact chambers to measure light transmission and wavelength as a real-time means of monitoring and optimizing the process.

Heat absorbents, such as carbon and salts, may be added to enhance the rate and extent of heat gain.

WWTP sludges and biosolids are treated using this inventive method. The method will also destroy residual pollutants and other chemicals within the sludge matrix during processing in one or more steps defined above—collectively or individually as active mechanisms.

A variety of systems are also claimed that utilize solar thermal technology to treat the sludges. The heated sludge serves as a heat medium for power generation or recovered heat use.

The method describes processes that while heating and processing the sludge, will destroy and weaken chemical bonding of the molecules within the sludge, lyse the microbial mass, break-up polymeric slimes, and weaken water bonding to make the sludges, after processing, easier to dewater (thus increasing the solids content, reducing dewatering polymer/coagulant demand, and stabilize the solids mass).

In one or more embodiments, a cavitation or sonication step may be placed in front of the solar thermal unit to prime it for improved processing. In one or more embodiments, pH adjustment of the sludge may be performed to prime it for processing. The process primes the water phase of the sludge for improved treatment of the residual water phase. These processing steps may also be placed along the length of the heating zone.

In one or more embodiments, the overall process is applied prior to digestion as a means of improving the digestibility of the sludges and/or waters being placed into the digestion step.

In other embodiments, the process is applied to all influents to a digestion system to improve digestibility (examples, increased biogas production, increased methane and hydrogen content, higher solids removal, etc.).

The process does not require pH adjustment like those processing systems that do add a base thereby requiring pH adjustment after processing, thus the pH characteristics of the final product will not be an issue for the invention disclosed.

In one or more embodiments, the method removes a significant portion of the water via steam generation thereby also dewatering the sludge.

In one or more embodiments, the heated sludge components are used as recovered heat to heat the anaerobic digesters and/or the other bioreactor systems at the WWTP (aerobic biotreatment) along with the physical systems (skimmers, clarifiers, and grid chambers)

In one or more embodiments, the inventive method for passing sludges through a solar thermal system so that said sludges are heated to a target temperature is as follows:

The solar thermal system comprises a heat zone and said heat zone comprises at least one contact chamber. In one embodiment, chemical oxidizers comprising one or more of the following: ozone, hydrogen peroxide, sulfur dioxide, and permanganates, are added to said sludges prior to passage through said heat zone. In one or more embodiments, photosensitizers comprising ketones and dyes that enhance the extent and rate of treatment of said sludges are added into said sludges prior to entrance of said sludges into said heat zone. In one or more embodiments, Photocatalysts comprising titanium dioxides or zinc oxides, are added into said sludges prior to entrance of said sludges into said heat zone as a means of producing radical species. In one or more embodiments, the pH of said sludges is adjusted to ensure said sludges meat classification standards of Class A or Class B. In one or more embodiments, heat absorbents comprising carbon or salts or a combination thereof are added to said sludges within said heat zone. In one or more embodiments, photometers are added into said at least one heating zone contact chamber to measure light transmission and wavelength as a real-time monitoring means. In one or more embodiments, photocatalysts are added by mounting substrates into said heating zone. In one or more embodiments, photocatalysts are added by adding a slurry within said heating zone. In one or more embodiments, secondary mirrors are added into said heating zone chamber such that any stray photons are directed back toward said sludges in said heating zone. In one or more embodiments, polymers are added are added to said sludges prior to passage through said heat zone and wherein said polymers enhance photolytic treatment and prepare said sludges for later dewatering.

For the purpose of understanding the Method for Treating Sludge Using Solar Thermal Concentrators, references are made in the text to exemplary embodiments of the Method for Treating Sludge Using Solar Thermal Concentrators, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Although the invention has been described with reference to the above examples, it will be understood that modifications and variations are encompassed within the spirit and scope of the invention. Accordingly, the invention is limited only by the following claims.

1. A method for treating sludge comprising passing sludges through a solar thermal system so that said sludges are heated to a target temperature; wherein said solar thermal system comprises a heat zone and said heat zone comprises at least one contact chamber.

2. The method of claim 1 wherein chemical oxidizers comprising one or more of the following: ozone, hydrogen peroxide, sulfur dioxide, and permanganates, are added to said sludges prior to passage through said heat zone.

3. The method of claim 1 wherein photosensitizers comprising ketones and dyes that enhance the extent and rate of treatment of said sludges are added into said sludges prior to entrance of said sludges into said heat zone.

4. The method of claim 1 wherein Photocatalysts comprising titanium dioxides or zinc oxides, are added into said sludges prior to entrance of said sludges into said heat zone as a means of producing radical species.

5. The method of claim 1 wherein the pH of said sludges is adjusted to ensure said sludges meat classification standards of Class A or Class B.

6. The method of claim 1 wherein heat absorbents comprising carbon or salts or a combination thereof are added to said sludges within said heat zone.

7. The method of claim 1 wherein photometers are added into said at least one heating zone contact chamber to measure light transmission and wavelength as a real-time monitoring means.

8. The method of claim 1 wherein photocatalysts are added by mounting substrates into said heating zone.

9. The method of claim 1 wherein photocatalysts are added by adding a slurry within said heating zone

10. The method of claim 1 wherein secondary mirrors are added into said heating zone chamber such that any stray photons are directed back toward said sludges in said heating zone.

11. The method of claim 1 wherein polymers are added are added to said sludges prior to passage through said heat zone and wherein said polymers enhance photolytic treatment and prepare said sludges for later dewatering.

12. A method for treating microbial suspensions that contain pathogens or microbial populations comprising passing said suspensions through a solar thermal system so that said suspensions are heated to a target temperature; wherein said solar thermal system comprises a heat zone and said heat zone comprises at least one contact chamber.
